(19) United States
(12) Patent Application Publication
(10) Pub. No.: US 2009/0207382 A1
(43) Pub. Date: Aug. 20, 2009

(54) Projecting System

(75) Inventors: Chi-Hung Hsiao, Taipei County (TW); Hung-Jen Wei, Nantou County (TW); Chun-Ming Shen, Taipei city (TW)

Correspondence Address: COVENANT IP CONSULTING CO., P.O. BOX 34-306 TAIPEI CITY, TAIPEI, 10499, TW

(73) Assignee: QISDA CORPORATION, Taoyuan (TW)

(21) Appl. No.: 12/367,503

(22) Filed: Feb. 7, 2009

(30) Foreign Application Priority Data
Feb. 20, 2008 (TW) 097105857

(51) Int. Cl. G03B 21/16

(52) U.S. Cl. 353/58; 353/61

(57) ABSTRACT

A projecting system including a light source module, a flow-conducting member, and a blower is provided. The flow-conducting member includes a hollow body, and at least one part of the light source module is disposed in the body. The body has an inlet and an outlet. The blower is adjacent to the inlet and used for blowing a flow toward the inlet along a first direction. The flow will leave the outlet along a second direction different from the first direction. Utilizing the flow-conducting method and disposition for fans/blowers according to the invention, even if plural light sources are disposed adjacent to each other, the heat generated by the light sources can be effectively dissipated.

### BACKGROUND OF THE INVENTION

1. Field of the Invention

The invention relates to a projecting system and, more particularly, to a heat dissipating mechanism in the projecting system.

2. Description of the Prior Art

In recent years, with the advance of various electronic products, both commercial and household multimedia systems have been getting more and more popular. The most important hardware in a multimedia system is generally the display apparatus for displaying images. Therefore, the methods to enhance the quality of the display apparatus are the most important considerations for designers and relative manufacturers.

A projecting system has the advantages of small size, easy setting, providing big-size images, and so on. Therefore, more and more public places, enterprises, and family theaters have adopted the projecting system as their display apparatus. Because public places are mostly bright and well-lighted, the brightness of projecting system has to be increased correspondingly, so as not to make the observer feel that the screen is too dark and the images cannot be seen clearly.

Most projecting systems utilize a single mercury lamp or tungsten lamp as the inner light source. In order to comply with the aforesaid needs in bright places, some projecting systems increase the brightness by adding the number of inner light sources. As known by those skilled in the art, the heat dissipating mechanism in the projecting system is very important. Once the efficiency of dissipating heat is not high enough, lamps, optical devices, or circuits in projecting system can be damaged or their life might be shortened. Because the light source generates most of the heat in the projecting system, the designing of a superior heat dissipating mechanism is especially important for the projecting system with a plurality of light sources.

In order to avoid the heat generated by light sources from being concentrated, the distances between each light source must be increased. In general, the light sources are disposed far away from each other to allow large spaces between each other. However, this kind of configuration has the drawback of bad space utility. In other words, in order to increase the brightness, the volume of projecting system becomes much bigger and heavier, which is another shortcoming.

### SUMMARY OF THE INVENTION

In order to solve the aforesaid problems, the invention provides a projecting system, wherein the flow-conducting method and the fan disposition can assist the light sources and the optical module in dissipating heat more effectively. Therefore, two or more light sources are allowed to be disposed quite close to each other, so as to solve the problem in prior arts that the volume of the projecting system gets too big.

The first embodiment according to the invention is a projecting system including a light source, a flow-conducting member, and a fan. The flow-conducting member includes a hollow body, and at least one part of the light source modules is disposed in the body. The body has an inlet and an outlet. The fan is disposed adjacent to the inlet for blowing a flow toward the inlet along a first direction. The flow leaves the outlet along a second direction, which differs from the first direction.

The second embodiment according to the invention is also a projecting system including an optical module, a first fan, and a second fan. The first fan is used for guiding a flow into the projecting system, and the flow blows toward a first part of the optical module along a first direction. The second fan is used for blowing the flow toward a second part of the optical module along a second direction which differs from the first direction.

The advantage and spirit of the invention may be understood by the following recitations together with the appended drawings.

### BRIEF DESCRIPTION OF THE APPENDED DRAWINGS

FIG. 1, FIG. 2(A), and FIG. 2(B) are schematic diagrams illustrating a light source, a flow-conducting member, and a fan in an embodiment according to the invention.

FIG. 3(A) and FIG. 3(B) illustrate two light sources in an embodiment according to the invention.

FIG. 4(A) and FIG. 4(B) illustrate the inner disposition diagram and the heat dissipating path schematic diagram in the projecting system in an embodiment according to the invention.

FIG. 4(C) shows an embodiment when the projecting system in FIG. 4(A) further includes a heat-dissipating module.

### DETAILED DESCRIPTION OF THE INVENTION

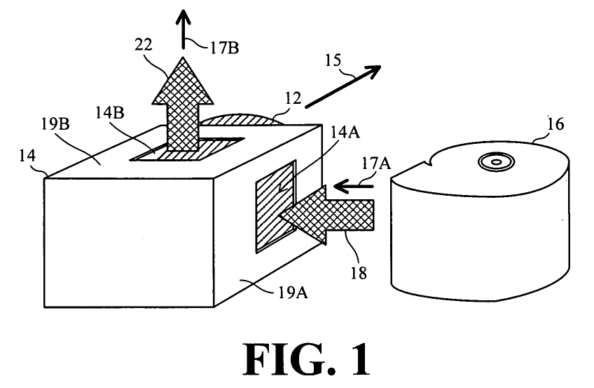

An embodiment according to the invention is a projecting system including a first light source module 12, a first flow-conducting member 14, and a fan 16. Please refer to FIG. 1, which is a schematic diagram of the devices. In this embodiment, the first flow-conducting member 14 has the function of guiding the flow and can also be a support for supporting the first light source module 12 at the same time. In order to easily explain it, the other devices in the projecting system (e.g., the casing, circuit board, and optical module) are not shown in FIG. 1.

An arrow 15 in FIG. 1 represents the light radiating direction of the first light source module 12. In practice, the first light source module 12 can include a mercury lamp, tungsten lamp, light emitting diode (LED) lamp, or other luminous bodies. In brief, the heat dissipating mechanism of the invention can be applied to various projecting systems with any luminous body.

As shown in FIG. 1, the first flow-conducting member 14 includes a hollow body, and the first light source module 12 is disposed in the hollow body. The first flow-conducting member 14 has an inlet 14A, an outlet 14B, a first side wall 19A, and a second side wall 19B. In this embodiment, the inlet 14A and the outlet 14B are respectively disposed on the first side wall 19A and the second side wall 19B. The first side wall 19A and the second side wall 19B are adjacent to each other. Additionally, the inlet 14A is disposed on one side of the first light source module 12, and the outlet 14B is disposed above the first light source module 12. The first side wall 19A and the second side wall 19B are disposed around the light radiating direction 15, but they do not stop the light from being proceeded.

In practical applications, the first fan 16 can be a blower. The first fan 16 is disposed near the inlet 14A for blowing the flow 18 toward the inlet 14A along a first direction 17A. After being blown into the inlet 14A, the flow 18 can assist the air around the first light source module 12 to flow smoothly, so as to guide the heat away from the first light source 12.

Further, the flow 22 with the aforesaid heat (i.e. the flow 18 after being heated) leaves the outlet 14B along a second direction 17B. As shown in FIG. 1, because the outlet 14B is disposed above the first light source module 12 in this embodiment, the second direction 17B is substantially in alliance with the surface normal direction of the outlet 14B and is also substantially perpendicular to the first light radiating direction 15 and the first direction 17A.

As shown in FIG. 2(A), besides the first light source module 12, the first flow-conducting member 14, and the first fan 16, the projecting system can further include a second fan 20 near the outlet 14B such as an exhaust fan, so as to assist the flow 22 near the outlet 14B in leaving the first light source module 12. In this condition, the flow 22 left the first light source module 12 can be influenced by the second fan 20, as shown in FIG. 1, and its direction is not necessarily perpendicular to the first light radiating direction 15 and the first direction 17A. In principle, the direction of the flow 22 left the first light source module 12 is slightly deflecting toward the second fan 20 from the second direction 17B.

In practical applications, the outlet 14B is disposed above the first flow-conducting member 14, hence the second fan 20 can be disposed slightly higher than the first flow-conducting member 14, so as to smoothly guide the flow 22 away from the first light source module 12.

Additionally, as shown in FIG. 2(B), there can be only one part of first light source module 12 disposed in the hollow body of the first flow-conducting member 14. Further, the proceeding direction of the flow 18 provided by the first fan 16 (i.e. the first direction 17A in FIG. 1) is not necessarily perpendicular to the side wall in the first flow-conducting member 14 where the inlet 14A is disposed. In general, the heat is most concentrated on the lamp of the optical module. For the disposition as shown in FIG. 2(B), after entering the first flow-conducting member 14, the flow 18 provided by the first fan 16 can flow into a lampshade of the first light source module 12 (as shown in dotted line) for assisting the lamp device in lowering the temperature.

In practical applications, the projecting system sometimes can be hung on the ceiling in order to save the space. In some conditions, the projecting system can also be hung upside down for complying with the various space placements. According to the invention, to comply with the aforesaid condition, the outlet 14B can also be disposed on the side wall corresponding to the second side wall 19B and below the first light source module 12.

Compared to the conditions when the outlet is disposed in lateral, front or back of the first light source module 12, disposing the outlet 14B above or below the first light source module can effectively avoid the heat generated by the first light source module 12 from flowing into other directions around the first light source module 12. Further, the above disposition can prevent the heat from influencing the other devices near the first light source module 12 (such as another light source module or other circuits/optical devices).

In addition, the symmetry of temperature is quite an important consideration in designing the lamp in the projecting system. For instance, many specifications of lamps limit the durable temperature range or temperature differences at the upper and lower sides of the lamp. Once the temperature of the lamp exceeds the limits, the lamp can be broken because of the asymmetrical heat distribution.

According to the invention, the flow 18 enters into the side of the first light source module 12, and the flow 22 leaves the light source module 12 above or below. This arrangement will not cause much difference in temperature between the first light source module 12 above and below, so as not to have the negative influence of the temperature symmetry on the first light source module 12.

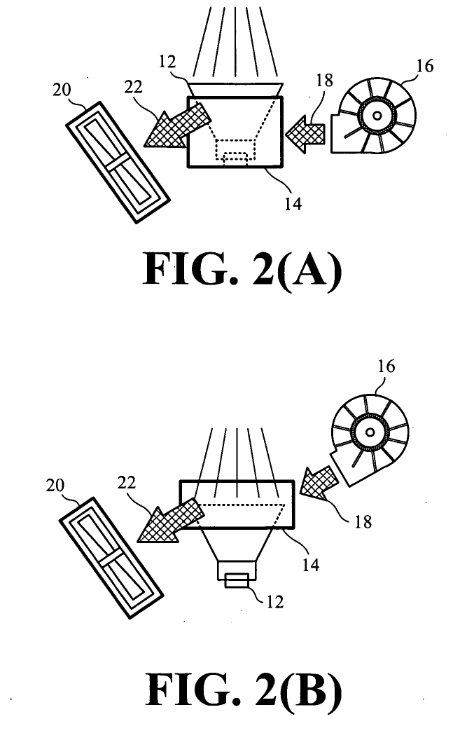

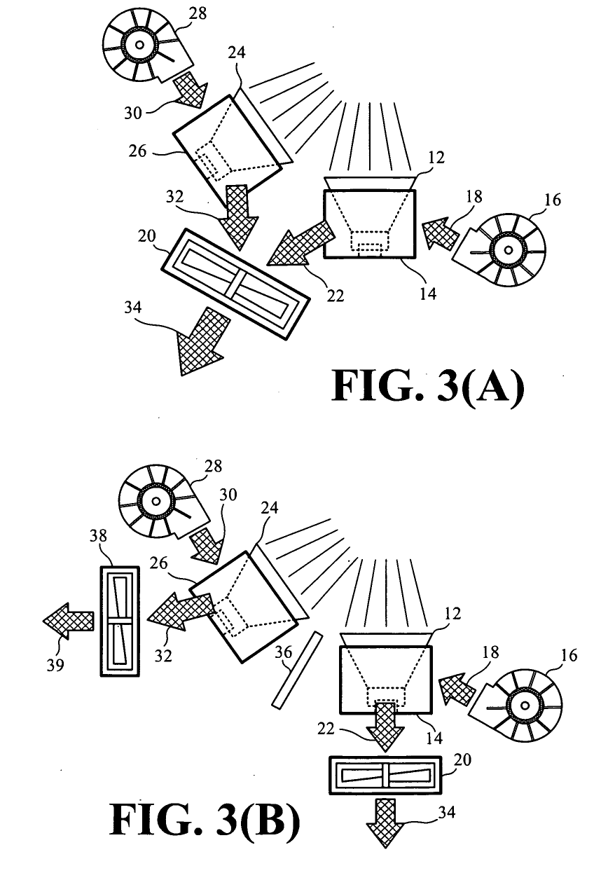

Please refer to FIG. 3(A), which is an embodiment when the projecting system includes two light source modules. As shown in FIG. 3(A), the projecting system further includes a second light source module 24, a second flow-conducting member 26, and a third fan 28.

The second flow-conducting member 26 has an inlet and an outlet, which is similar to the aforesaid first flow-conducting member. The outlet is disposed above the second light source module 24 and the inlet is disposed on one side of the second light source module 24. In other words, the inlet and the outlet are respectively disposed on two adjacent side walls in the second flow-conducting member 26.

The third fan 28 is disposed near the inlet of the second flow-conducting member 26 for blowing the flow 30 toward the inlet. According to the invention, because the outlet of the second flow-conducting member 26 is disposed above the second light source module 24, the direction that the flow 32 leaves the outlet is substantially perpendicular to the light radiating direction of the second light source module 24 and the direction that the flow 30 enters into the second flow-conducting member 26. Therefore, the heat cannot be guided to the devices disposed around the second light source module 24.

In this embodiment, the second fan 20 is disposed adjacent to the first flow-conducting member 14 and the second flow-conducting member 26 for assisting the flows 22 and 32 from the outlets of the two flow-conducting members in leaving the projecting system (such as the flow 34). In practice, the second fan 20 can be disposed higher than the first flow-conducting member 14 and the second flow-conducting member 24, so as to fluently guide the flows 22 and 32 away from the light source modules.

As described above, the heat generated by the first light source module 12 can be guided as the flow 22 by the first flow-conducting member 14 and the second fan 20. And then the flow 22 is drained away from the projecting system via the second fan 20. Therefore, the heat cannot have much influence on the second light source module 24 adjacent to the first light source module 12. Similarly, the heat generated by the second light source module 24 (shown as the flow 32) is drained away from the projecting system via the second fan 20 and cannot have much influence on the first light source module 12, either. Therefore, farther distance between the first light source module 12 and the second light source 24 is not necessary.

Please refer to FIG. 3(B). As shown in FIG. 3(B), the projecting system can further include a fourth fan 38 and a partition 36 disposed between the first light source module 12 and the second light source module 24. In this embodiment, the second fan 20 is primarily used for draining away the heat adjacent to the first light source module 12 (such as the flows 22 and 34), and the heat generated by the second light source module 24 is primarily guided away via the fourth fan 38 (such as the flows 32 and 39). In other words, the fourth fan 38 can further enhance the heat dissipating efficiency around the second light source module 24. On the other hand, the partition 36 is used for lowering the influence of the heat respectively generated by the first light source module 12 and the second light source module 24. By adding the fourth fan 38 and the partition 36, the heat dissipating efficiency for the projecting system can be enhanced.

As mentioned above, by utilizing the flow-conducting method and the aforesaid arrangement of the fans, even if a plurality of light source modules are disposed adjacent to each other in the projecting system, great heat dissipating efficiency can be achieved. Thereby, the space in the projecting system can be slashed to solve the problem in the prior arts that the volume of two or more light sources projecting system is too big.

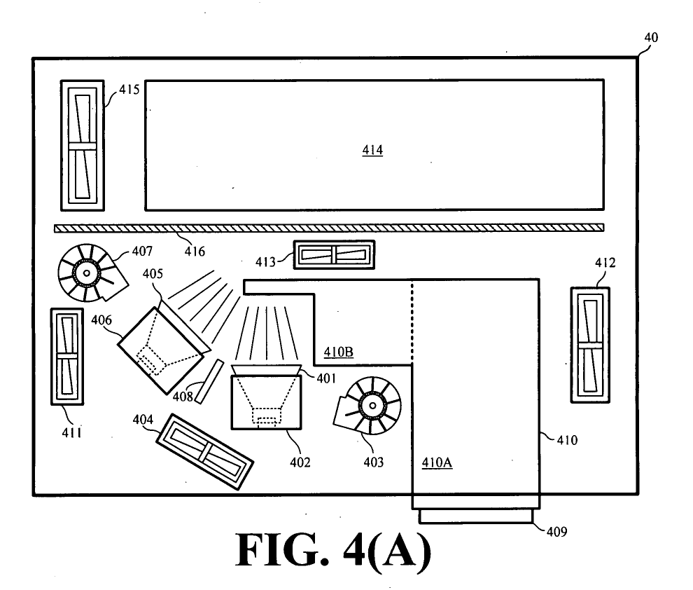

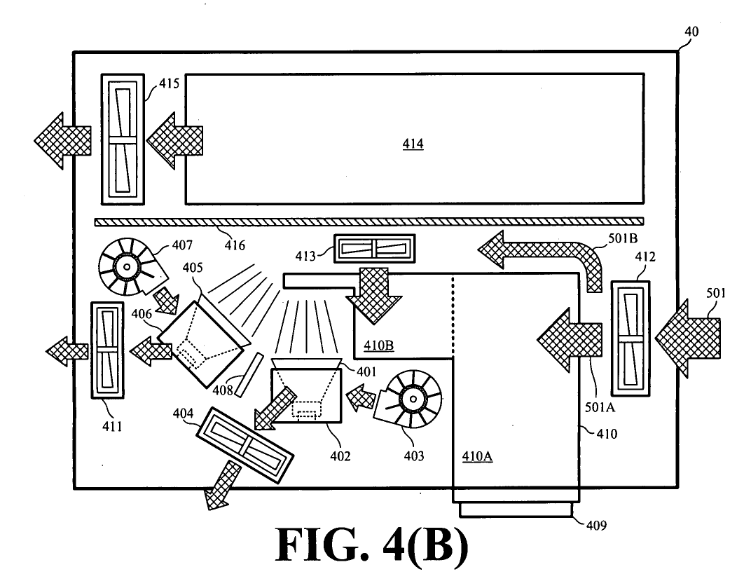

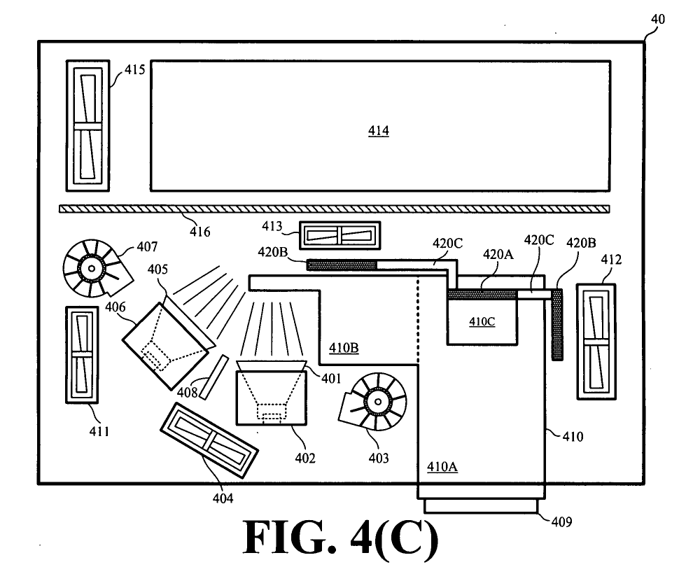

Please refer to FIG. 4(A), which is the inner disposition diagram of a projecting system in an embodiment according to the invention. The projecting system 40 includes the following components: a first light source module 401, a first flow-conducting member 402, a first fan 403, a second fan 404, a second light source module 405, a second flow-conducting member 406, a third fan 407, a first partition 408, a lens module 409, an optical module 410, a fourth fan 411, a fifth fan 412, a sixth fan 413, a circuit board 414, a seventh fan 415, and a second partition 416.

As shown in FIG. 4(A), the optical module 410 can be divided into two parts in this embodiment. For example, one part of the optical module 410A can include the lens apparatus for refracting/reflecting the light and a reflection device for determining the pixel brightness (such as a digital micro-reflection device). Another part of the optical module 410B can include the light-collecting devices for collecting the light provided by the light source modules (401, 405) and/or the color wheel for filtering the light. Accordingly, the first light radiating direction of the first light source module 401 and the second light radiating direction of the second light source module 405 both aim at the optical module 410. In addition, the lens module 409 is used for projecting the light out the projecting system 40, and the circuit board 413 can include various control circuits and power installations.

FIG. 4(B) is a schematic diagram illustrating the heat dissipating flows in the projecting system 40. As shown in FIG. 4(B), the first fan 403, the second fan 404, the third fan 407, and the fourth fan 411 can provide assistance to dissipate the heat generated by the first light source module 401 and the second light source module 405 in draining them away from the projecting system 40. The first partition 408 can lower the influence of the heat respectively generated by the two light source modules on each other. According to the invention, in addition to draining away the heat generated by the light source modules, the second fan 404 and the fourth fan 411 can also guide and drain away the heat generated by the optical module 410 in the right side of FIG. 4(B), so as to enhance the total heat dissipating efficiency of projecting system 40.

The fifth fan 412 is used for guiding the flow 501 into the projecting system 40. As shown in FIG. 4(B), after entering the projecting system 40, the first part 501A of the flow 501 is blown toward the first part 410A of the optical module 410, and the second part 510B of the flow 501 flows to the sixth fan 413 via the gap between the optical module 410 and the second partition 416. The flow 501A can assist the total optical module 410 (including the first part 410A and the second part 410B) in dissipating the heat.

On the other hand, the sixth fan 413 can guide the flow 510B to change its direction and blow toward the second part of the optical module 410, so as to assist in dissipating the heat in the second part 410B. As shown in FIG. 4(B), the direction of the flow changed by the sixth fan 413 is substantially perpendicular to the original direction of the flow 501B. In practical applications, an aperture (not shown) can be formed below the casing of the projecting system 40 and corresponding to the fifth fan 412 for guiding more flows into the projecting system 40, so as to better the ventilation.

Please refer to FIG. 4(C). In practice, a heat dissipating module can be disposed externally on the reflection device 410C in the optical module 410. As shown in FIG. 4(C), the heat dissipating module includes a first heat dissipating device 420A, two second heat dissipating devices 420B, and two heat-conducting tubes 420C. For example, the first heat dissipating device and the second heat dissipating devices can be a heat dissipating aluminum plate, heat-conducting plate, or heat dissipating fin.

The first heat dissipating device 420A is connected to the reflection device 410C, and both sides of the first heat dissipating device 420A respectively have the heat conducting tubes 420C connected to the second heat dissipating device 420B. As shown in FIG. 4(C), the two second heat dissipating devices 420B are respectively disposed adjacent to the fifth fan 412 and the sixth fan 413. The heat generated by the reflection device 410C is guided to the second heat dissipating devices 420B via the first heat dissipating device 420A and the heat conducting tubes 420C and then is drained away by the fifth fan 412 and the sixth fan 413.

In addition, as shown in FIG. 4(B), the seventh fan 415 is used for draining the heat generated by the circuit board 413 away from the projecting system 40. The second partition 416 is used for separating the circuit device and the optical device and avoids the heat generated by the two parts from influencing each other. In practical applications, in addition to the aforesaid fans, more fans or heat conducting devices can definitely also be disposed in the projecting system 40 for dissipating the heat.

As mentioned above, the flow-conducting method and the disposition of the fans, according to the invention, can assist each part of the projecting system (including the optical module, circuit board, optical module, and so on) in dissipating the heat efficiently. Therefore, in a projecting system according to the invention not only allows a plurality of light source modules to be disposed quite close to each other, but also effectively shortens the distance between each part. And further it can solve the problem in the prior arts that the volume of the projecting system with a plurality of light sources gets too big.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A projecting system, comprising:
a first light source module with a first light radiating direction;
a first flow-conducting member comprising a hollow first body, at least one part of the first light source module being disposed in the first body, the first body having a first inlet and a first outlet; and
a first fan, adjacent to the first inlet, for blowing a first flow toward the first inlet along a first direction;
wherein the first flow leaves the first outlet along a second direction, and the first direction differs from the second direction.

2. The projecting system of claim 1, wherein the second direction is substantially perpendicular to the first light radiating direction and the first direction.

3. The projecting system of claim 1, wherein the first flow-conducting member has a first side wall and a second side wall adjacent to each other and disposed around the light radiating direction, the first inlet is disposed on the first side wall, and the first outlet is disposed on the second side wall.

4. The projecting system of claim 1, further comprising:
a second fan, adjacent to the first outlet, for assisting the first flow near the first outlet in leaving the projecting system.

5. The projecting system of claim 1, wherein the first flow-conducting member is a holder for supporting the first light source module.

6. The projecting system of claim 1, further comprising:
a second light source module with a second light radiating direction and disposed adjacent to the first light source module.

7. The projecting system of claim 6, further comprising:
a partition disposed between the first light source module and the second light source module; wherein the first light radiating direction and the second light radiating direction both aim at an optical module.

8. The projecting system of claim 6, further comprising:
a second flow-conducting member comprising a hollow second body, at least one part of the second light source being disposed in the second body, the second body having a second inlet and a second outlet; and
a third fan, adjacent to the second inlet, for blowing a second flow toward the second inlet along a third direction;
wherein the second flow leaves the second outlet along a fourth direction, and the third direction is different from the fourth direction.

9. The projecting system of claim 8, wherein the fourth direction is substantially perpendicular to the second light radiating direction and the third direction.

10. The projecting system of claim 8, further comprising:
a second fan, adjacent to the first outlet and the second outlet, for assisting the first flow near the first outlet and the second flow near the second outlet in leaving the projecting system.

11. The projecting system of claim 8, further comprising:
a second fan, adjacent to the first outlet and higher than the first flow-conducting member, for assisting the first flow near the first outlet in leaving the projecting system; and
a fourth fan, adjacent to the second outlet and higher than the second flow-conducting member, for assisting the second flow near the second outlet in leaving the projecting system.

12. A projecting system, comprising:
an optical module;
a first fan for guiding a flow into the projecting system, the flow being guided toward a first part of the optical module along a first direction; and
a second fan for blowing the flow toward a second part of the optical module along a second direction, the second direction being different from the first direction.

13. The projecting system of claim 12, wherein the second direction is substantially perpendicular to the first direction.

14. The projecting system of claim 12, wherein the first part comprises a lens apparatus and a reflection device.

15. The projecting system of claim 14, further comprising a heat dissipating module disposed at the external of the reflection device.

16. The projecting system of claim 15, wherein the heat dissipating module comprises a first heat dissipating device, a second heat dissipating device, and a heat conducting tube, the heat conducting tube connects the first heat dissipating device with the second heat dissipating device, the first heat dissipating device is connected with the reflection device, and the second heat dissipating device is disposed adjacent to one of the first fan and the second fan.

17. The projecting system of claim 16, wherein the first heat dissipating device and the second heat dissipating device respectively has a heat dissipating aluminum sheet, a heat conducting plate, or a heat dissipating fin.

18. The projecting system of claim 12, wherein the second part of the optical module comprises a light source and a color wheel.

19. The projecting system of claim 12, further comprising:
a casing for containing the optical module, the first fan, and the second fan, and the casing thereon having an aperture corresponding to the second fan.

20. The projecting system of claim 12, further comprising:
a circuit board; and
a partition disposed between the circuit board and an optical path relative to the optical module.
